(19) United States
(12) Patent Application Publication
(10) Pub. No.: US 2012/0259848 A1
(43) Pub. Date: Oct. 11, 2012

(54) SYSTEM AND METHOD FOR AUTOMATICALLY BUILDING A SEARCH DATABASE FOR DIGITAL DATA OF MEDIUMS

(76) Inventors: Ming-Hsun LIU, Taipei (TW); Chung-Hsuan Tsai, Taipei (TW)

(21) Appl. No.: 13/083,998

(22) Filed: Apr. 11, 2011

(51) Int. Cl. G06F 17/30

(52) U.S. Cl. 707/736; 707/E17.122

(57) ABSTRACT

A method for automatically building a search database for digital data of mediums by executing a software program stored in a memory of a computer, the method comprising: receiving a first request for selecting files to be processed; receiving a second request for selecting a target medium; and creating a search database for the selected files according to the target medium.

### BACKGROUND OF THE INVENTION

1. Field of the Invention

The present invention relates to a system and a method for automatically building a search database for digital data of mediums.

2. Description of the Related Art

Today, people use various mediums such as MO (magnetic optical) discs, CDs (compact discs), LDs (laser discs), DVDs (digital versatile discs), BDs (blue ray discs), or an HD (hard disc) to backup their digital data. In order to ensure that the digital data are not changed, it is very common to use read-only mediums to store the digital data. However, it is not easy for users to identify the content of the digital data from the outward appearance of the mediums.

Traditionally, users may use management software to build an index for existing files. Building such an index requires that the users first build “files”, and then build the index according to the built files. If there is no file built, it is not possible to have an index for the files.

Therefore, there is a need to provide a system and a method for automatically building a search database for digital data of mediums.

### SUMMARY OF THE INVENTION

It is an object of the present invention to provide a system and a method that can automatically build a search database for digital data of mediums.

It is another object of the present invention to provide a system and a method that can automatically build a search database for digital data of mediums when reproducing the digital data.

To achieve the abovementioned objects, the present invention provides a system for automatically building a search database for digital data of mediums comprising a first receiving module, a second receiving module, and a creating module. The first receiving module is used for receiving a first request for selecting files to be processed. The second receiving module is used for receiving a second request for selecting a target medium. The creating module is used for creating the search database for the selected files according to the target medium.

In a preferred embodiment, the system further comprises a processing module for processing the selected files when creating the search database. In addition, the system may further comprise a printing module for printing on the selected target medium.

The present invention also discloses a method for automatically building a search database for digital data of mediums by executing a software program stored in a memory of a computer, the method comprising:

S1: receiving a first request for selecting files to be processed;

S2: receiving a second request for selecting a target medium; and

S3: creating the search database for the selected files according to the target medium.

In a preferred embodiment, the method of the present invention comprises S4: processing the selected files when creating the search database. In addition, the method may further comprise S5: printing an image or a text on the selected target medium.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A and FIG. 1B illustrate an environmental schematic drawing according to an embodiment of the present invention.

FIG. 2 illustrates a structure of a computer according to the present invention.

FIG. 3 illustrates a block diagram according to the system of the present invention.

FIGS. 4A, 4B, 5A, 5B, 6A, and 6B illustrate interfaces according to one example of the present invention.

FIG. 7 shows a flow chart according to the method of the present invention.

### DETAILED DESCRIPTION OF THE PREFERRED EMBODIMENT

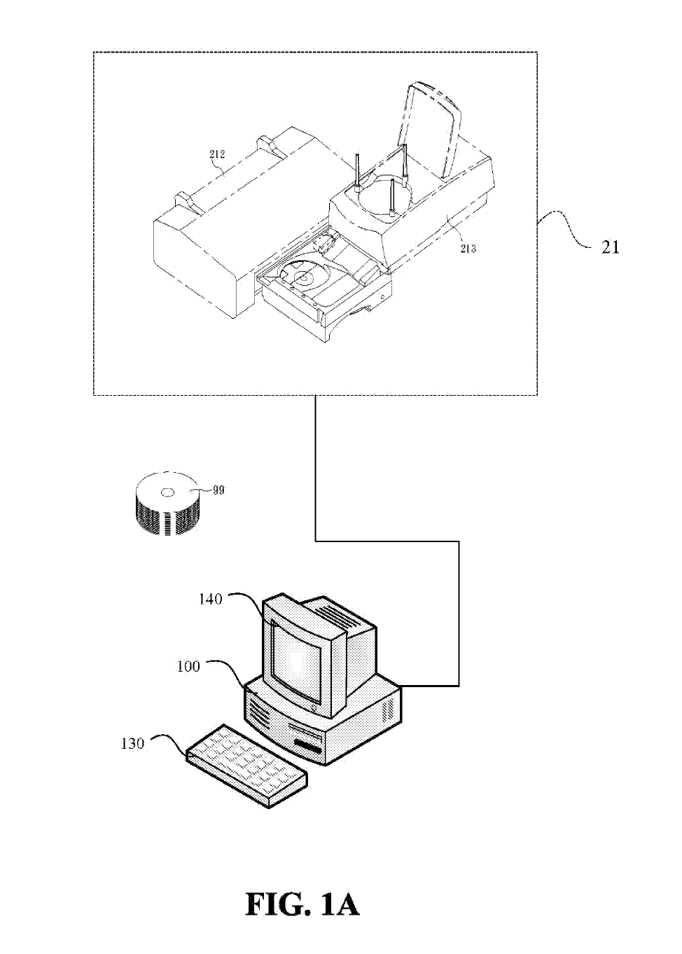

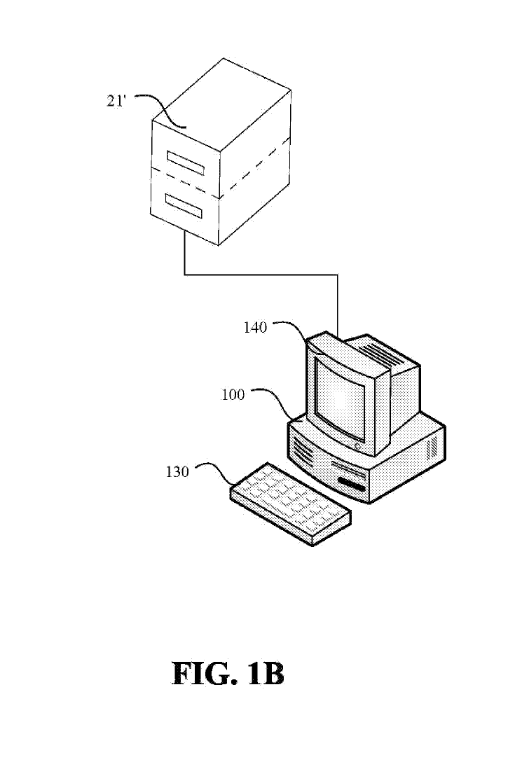

Please refer to FIG. 1A, which illustrates an environmental schematic drawing according to an embodiment of the present invention, for the following paragraphs. A user may utilize a computer 100 to execute the method of the present invention. The computer 100 is connected with a target medium processing device 21. For example, the target medium processing device 21 may comprise a printing device 212 and a medium processing device 213. When a disc 99 needs to be processed (such as recorded or verified) and printed, the disc will be sent to the processing device 213 for processing and to the printing device 212 for printing an image or a text on the disc. The image or the text is used for users to identify the content of the disc. Thus, when the user needs to reproduce his/her digital data into CDs or DVDs, the user may use the method or the system of the present invention to automatically build a database for the digital data of DVDs or CDs when reproducing them. In addition, as shown in FIG. 1B, the target medium processing device 21′ may be a multifunctional processing device, which can process mediums 99 (such as CDs or DVDs) and print on the mediums.

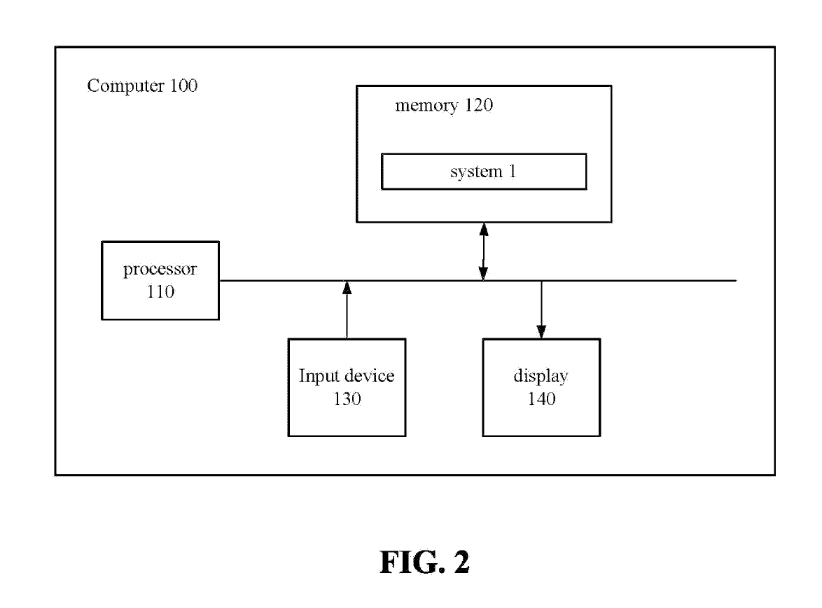

Please refer to FIG. 2. The computer 100 may comprise a processor 110, a memory 120, an input device 130, and a display 140. The system 1 of the present invention may be stored in the memory 120 for the processor 110 to execute. It should be understood that the block diagram of FIG. 2 is not intended to limit the present invention.

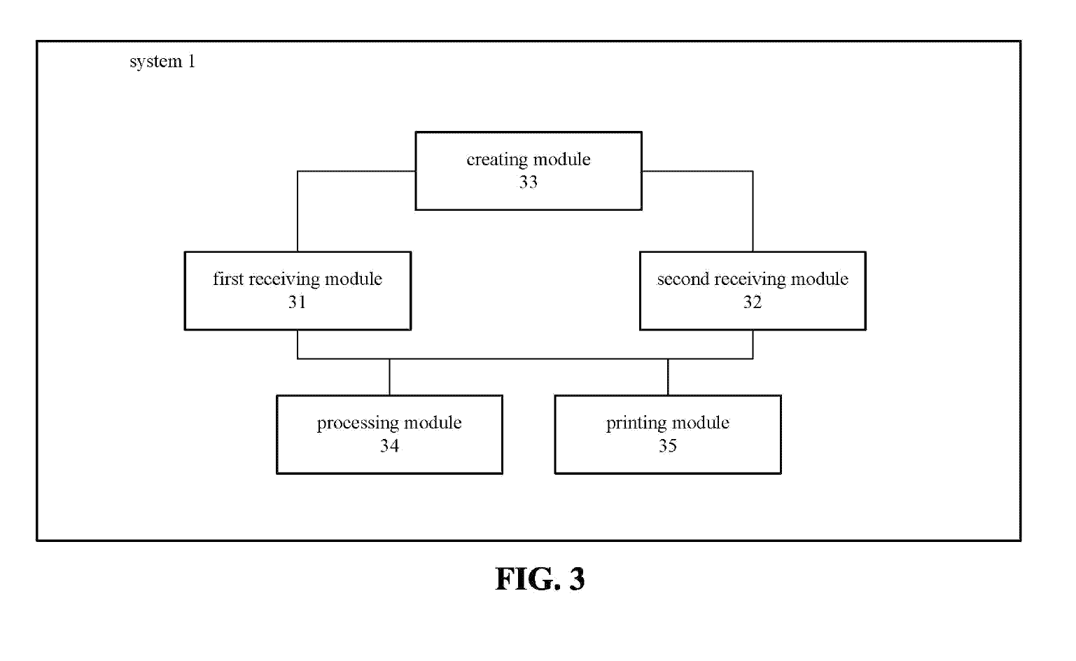

As shown in FIG. 3, the system according to the present invention comprises a first receiving module 31, a second receiving module 32, and a creating module 33 connected with the first receiving module 31 and the second receiving module 32. In a preferred embodiment, the system 1 further comprises a processing module 34 and a printing module 35, wherein the processing module 34 and the printing module 35 are connected with the first receiving module 31 and the second receiving module 32.

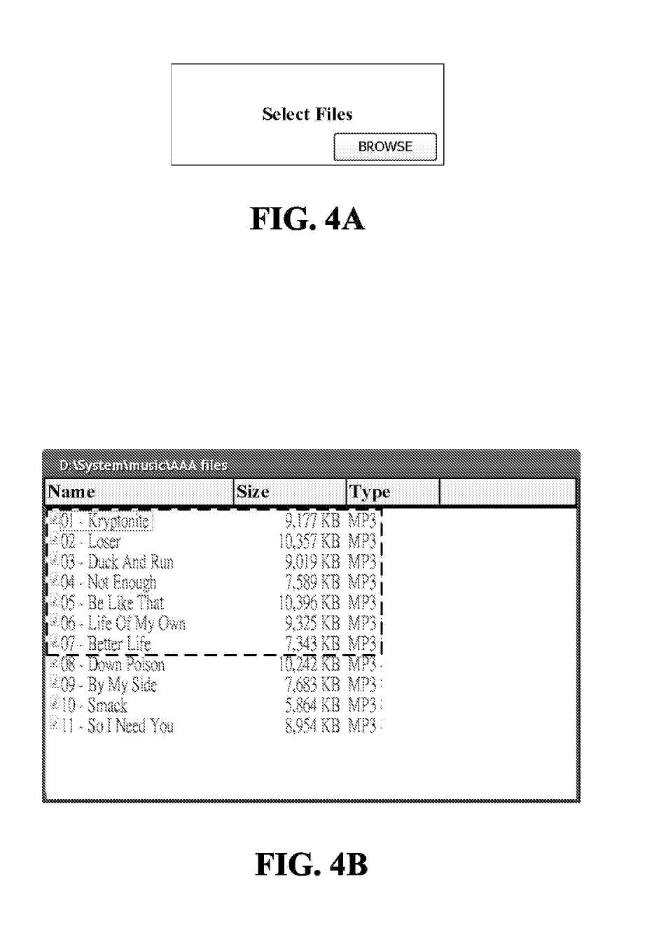

The first receiving module 31 is used for receiving a first request for selecting files to be processed. For example, a display 140, as shown in FIG. 2, can be used to display an interface for users to control the request through the input device 130. Please refer to FIG. 4A, which shows an example of the interface. The user can click on the “BROWSE” button. For example, the display 140 can show another interface as shown in FIG. 4B for the user to select files to be processed.

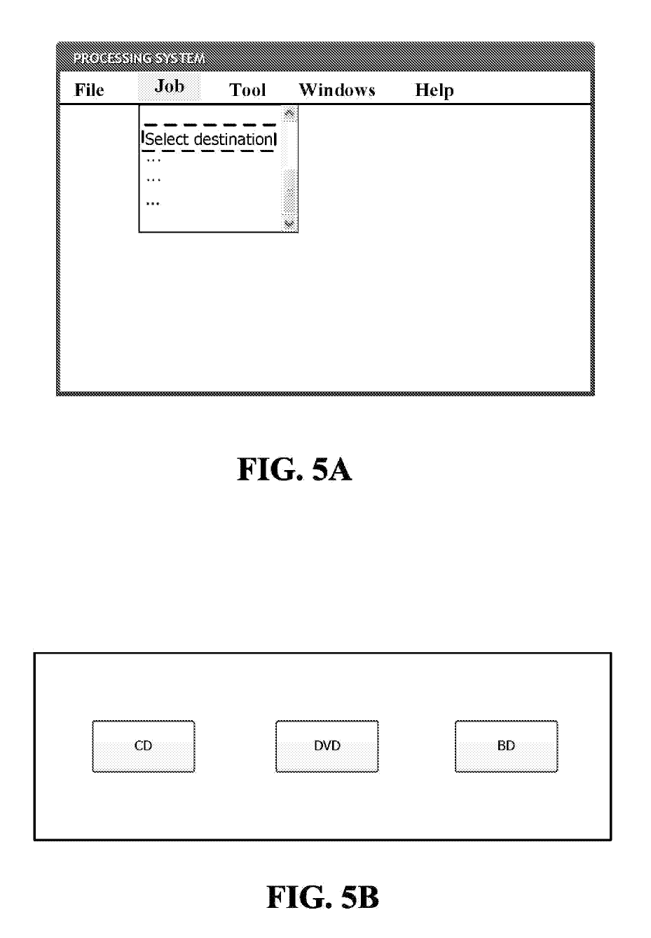

The second receiving module 32 is used for receiving a second request for selecting a target medium. The computer 100 shown in FIG. 1A or FIG. 1B can be connected with more than one target medium processing device (not shown). Every target medium device is different from the others. For example, one target medium device can process CDs, another target medium device can process DVDs, and the other target medium device can process BDs. Please refer to FIG. 5A. The user can click on the selection of “Select destination”. For example, the display 140 can show a corresponding interface, as shown in FIG. 5B, for the user to select a target medium, such as CD, or DVD, or BD. If the user clicks on the button for “DVD”, for example, the selected files will be recorded onto the DVDs.

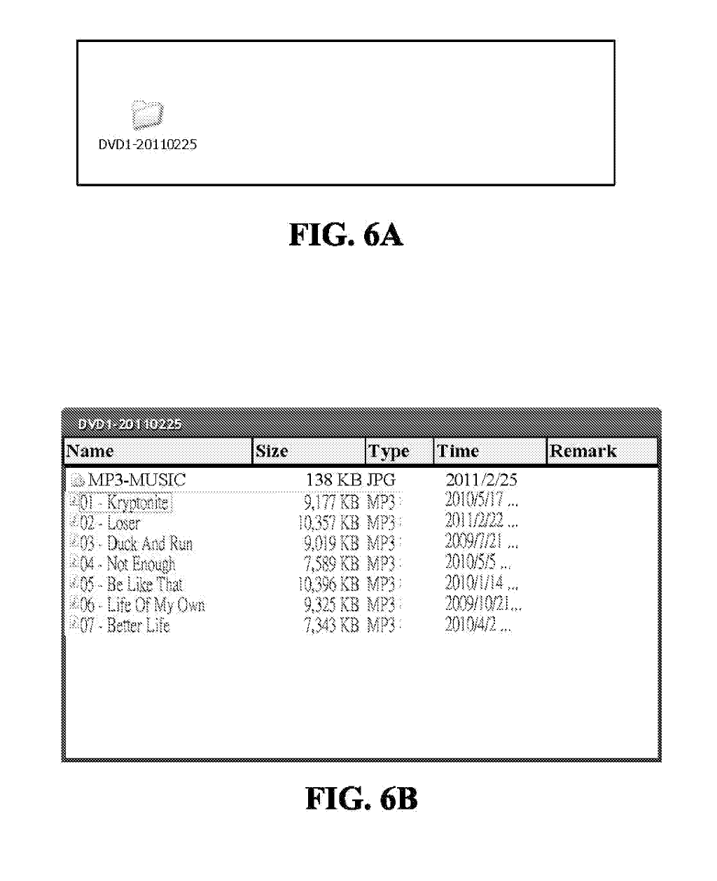

The creating module 33 of the present invention is used for creating a search database for the selected files according to the target medium. The search database may comprise a file name, a filename extension, a size, a date, a time, an attribute, a type, and a remark. For example, according to the files shown in FIG. 4B, a folder, as shown in FIG. 6A, can be created automatically. When clicking the folder, details (such as a file name, a filename extension, a size, a date, a time, an attribute, a type, and a remark) of the digital data recorded on the DVD can be displayed, as shown in FIG. 6B.

Preferably, the processing module 34 (shown in FIG. 3) processes the selected files when creating the search database. In addition, the printing module 35 can print an image or a text on the selected target medium. Accordingly, one target medium processing device 21 or 21′ in FIG. 1A or FIG. 1B processes the selected files (i.e., digital data) and prints the image or the text on the selected target medium. At the same time, the search database of the processed mediums can be built.

Although in the example in FIG. 6A, there is only one folder, it should be understood that a plurality of folders can be built when the selected files are stored into more than one medium (such as more than one DVD). Thus, it will be convenient for the users to have a search database at the same time when processing the mediums. The image or the text on the medium can be the same as the folder icon or the folder name. Thus, it will be easier for the user to understand the content of the medium through the search database without using a reader to read the medium.

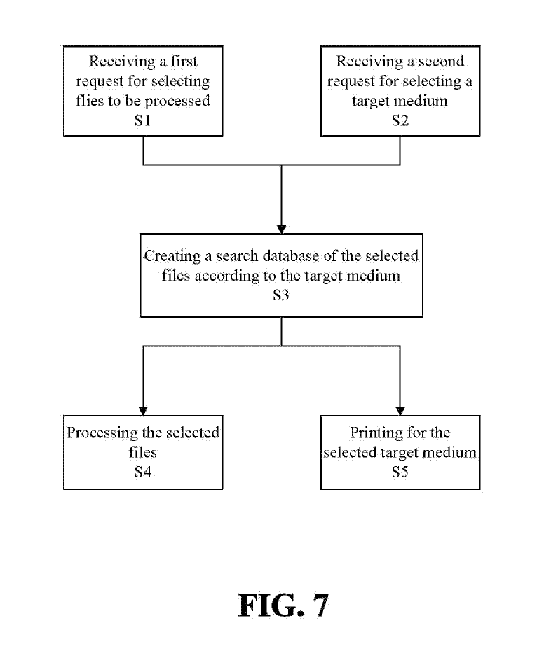

A method for identifying digital data and reproducing the same by executing a software program stored in a memory of a computer is also provided. Please refer to FIG. 7, which shows a flow chart of the method according to the present invention. The method comprises:

S1: receiving a first request for selecting files to be processed.

S2: receiving a second request for selecting a target medium. It should be understood that S1 and S2 are not in order. In other words, S2 can be performed first.

Then S3: creating a search database for the selected files according to the target medium.

In a preferred embodiment, the method of the present invention comprises S4: processing the selected files when creating the search database. In addition, the method may further comprise S5: printing for the selected target medium. Similarly, S4 and S5 are not in order.

Although the present invention has been explained in relation to its preferred embodiments, it is to be understood that many other possible modifications and variations can be made without departing from the spirit and scope of the invention as hereinafter claimed.

What is claimed is:

1. A system for automatically building a search database for digital data of mediums comprising:
a first receiving module for receiving a first request for selecting files to be processed;
a second receiving module for receiving a second request for selecting a target medium; and
a creating module for creating the search database for the selected files according to the target medium, wherein the creating module is connected with the first receiving module and the second receiving module.

2. The system as claimed in claim 1, further comprising a processing module for processing the selected files when creating the search database, wherein the processing module is connected with the first receiving module and the second receiving module.

3. The system as claimed in claim 1 further comprising a printing module for printing on the selected target medium, wherein the printing module is connected with the first receiving module and the second receiving module.

4. The system as claimed in claim 1, wherein the search database comprises a file name, a filename extension, a size, a date, a time, an attribute, a type, and a remark.

5. A method for automatically building a search database for digital data of mediums by executing a software program stored in a memory of a computer, the method comprising:
receiving a first request for selecting files to be processed;
receiving a second request for selecting a target medium; and
creating the search database for the selected files according to the target medium.

6. The method as claimed in claim 5 further comprising:
processing the selected files after creating the search database.

7. The method as claimed in claim 5 further comprising:
printing on the selected target medium.

8. The method as claimed in claim 5, wherein the search database comprises a file name, a filename extension, a size, a date, a time, an attribute, a type, and a remark.
